(19) United States
(12) Patent Application Publication
(10) Pub. No.: US 2011/0302018 A1
(43) Pub. Date: Dec. 8, 2011

(54) METHOD AND APPARATUS FOR VALIDATING REDEMPTION OF A COUPON

(75) Inventors: Troy NORCROSS, London (GB); Patrik GUSTAFSSON, Espoo (FI)

(73) Assignee: NOKIA CORPORATION, Espoo (FI)

(21) Appl. No.: 13/162,201

(22) Filed: Jun. 16, 2011

Related U.S. Application Data
(63) Continuation-in-part of application No. 12/773,592, filed on May 4, 2010.

(51) Int. Cl. G06Q 30/00

(52) U.S. Cl. 705/14.26

(57) ABSTRACT

An approach is provided for validating redemption of a coupon. The coupon management module causes, at least in part, presentation of a coupon via a device. Next, the coupon management module receives a first code in response to the presentation. Next, the coupon management module causes, at least in part, validation of a redemption of the coupon based, at least in part, on the first code. The validation is performed at the device, at a server, or a combination thereof. Next, the coupon management module retrieves a second code based, at least in part, on the coupon, the first code, or a combination thereof. Next, the coupon management module causes, at least in part, presentation of the second code for verification. The validation of the redemption of the coupon is further based, at least in part, on the verification of the second code.

### RELATED APPLICATION

This application is a continuation-in-part of prior application Ser. No. 12/773,592, “Method and Apparatus for Validating Redemption of a Coupon,” filed May 4, 2010, which is herein incorporated by reference in its entirety.

### BACKGROUND

Service providers and device manufacturers (e.g., wireless, cellular, electronic devices, etc.) are continually challenged to deliver value and convenience to consumers by, for example, providing compelling services in everyday lives. One area of interest has been use of coupons, and effective was to process them. Traditionally, a coupon is in a form of paper or a tangible item that can be physically presented to the merchant, and the merchant considers the coupon in sales of items to apply discount or provide a special deal according to the coupon. However, physical processes are performed to produce the traditional coupons, such as printing the coupons on a paper, and thus costs are incurred in producing the coupons. The merchant or a manufacturer may also need to incur additional cost to post the coupons in advertisements, newspapers, magazines, and etc. Electronic coupons that are less costly to distribute than paper coupons have become common and are also downloadable to a mobile device such as a mobile phone. Although electronic coupons may be easier to keep track than paper coupons, managing the use of electronic coupons has not been exploited extensively. Maintaining a record of uses of coupons may provide benefits such as prevention of overuse or misuse of the coupons as well as a trend in purchases and coupon uses. However, it takes a laborious process by the merchant to validate the coupons at the time of coupon redemption and keeping track of coupons that has been redeemed may consume time and resources at the merchant end. Further, the merchant may not have sufficient resources to implement and support a system to manage redemption of the coupons. Accordingly, service providers and device manufacturers face significant technical challenges to provide an effective and low-cost way to manage coupon uses.

### Some Example Embodiments

Therefore, there is a need for an approach for validating redemption of a coupon while involving low cost and ease of implementation by the merchant accepting the coupon.

According to one embodiment, a method comprises causing, at least in part, presentation of a coupon via a device. The method further comprises receiving a first code in response to the presentation. The method further comprises causing, at least in part, validation of a redemption of the coupon based, at least in part, on the first code. The validation is performed at the device, at a server, or a combination thereof. The method further comprises retrieving a second code based, at least in part, on the coupon, the first code, or a combination thereof. The method further comprises causing, at least in part, presentation of the second code for verification. The validation of the redemption of the coupon is based, at least in part, on the verification of the second code.

According to another embodiment, an apparatus comprising at least one processor, and at least one memory including computer program code, the at least one memory and the computer program code configured to, with the at least one processor, cause, at least in part, the apparatus to cause, at least in part, presentation of a coupon via a device. The apparatus is further caused to receive a first code in response to the presentation. The apparatus is further caused to cause, at least in part, validation of a redemption of the coupon based, at least in part, on the first code. The validation is performed at the device, at a server, or a combination thereof. The apparatus is further caused to retrieve a second code based, at least in part, on the coupon, the first code, or a combination thereof. The apparatus is further caused to cause, at least in part, presentation of the second code verification. The validation of the redemption of the coupon is further based, at least in part, on the verification of the second code.

According to another embodiment, a computer-readable storage medium carrying one or more sequences of one or more instructions which, when executed by one or more processors, cause, at least in part, an apparatus to cause, at least in part, presentation of a coupon via a device. The apparatus is further caused to receive a first code in response to the presentation. The apparatus is further caused to cause, at least in part, validation of a redemption of the coupon based, at least in part, on the first code. The validation is performed at the device, at a server, or a combination thereof. The apparatus is further caused to retrieve a second code based, at least in part, on the coupon, the first code, or a combination thereof. The apparatus is further caused to cause, at least in part, presentation of the second code verification. The validation of the redemption of the coupon is further based, at least in part, on the verification of the second code.

According to another embodiment, an apparatus comprises means for causing, at least in part, presentation of a coupon via a device. The apparatus further comprises means for receiving a first code in response to the presentation. The apparatus further comprises means for causing, at least in part, validation of a redemption of the coupon based, at least in part, on the first code. The validation is performed at the device, at a server, or a combination thereof. The apparatus further comprises means for retrieving a second code based, at least in part, on the coupon, the first code, or a combination thereof. The apparatus further comprises means for causing, at least in part, presentation of the second code for verification. The validation of the redemption of the coupon is based, at least in part, on the verification of the second code.

According to another embodiment, a method comprises causing, at least in part, presentation of a coupon via a device, the presentation including a representation of a status of the coupon. The method further comprises, in response to the presentation, generating a request to validate redemption of the coupon, the request including a code. The method further comprises receiving an indication of a validation of the redemption of the coupon based, at least in part, on the request. The method further comprises causing, at least in part, modification of representation of the status of the coupon based, at least in part, on the indication of the validation.

According to another embodiment, an apparatus comprising at least one processor, and at least one memory including computer program code, the at least one memory and the computer program code configured to, with the at least one processor, cause, at least in part, the apparatus to cause, at least in part, presentation of a coupon via a device, the presentation including a representation of a status of the coupon. The apparatus is further caused to, in response to the presentation; generate a request to validate redemption of the coupon, the request including a code. The apparatus is further caused to receive an indication of a validation of the redemption of the coupon based, at least in part, on the request. The apparatus is further caused to cause, at least in part, modification of representation of the status of the coupon based, at least in part, on the indication of the validation.

According to another embodiment, a computer-readable storage medium carrying one or more sequences of one or more instructions which, when executed by one or more processors, cause, at least in part, an apparatus to cause, at least in part, presentation of a coupon via a device, the presentation including a representation of a status of the coupon. The apparatus is further caused to, in response to the presentation; generate a request to validate redemption of the coupon, the request including a code. The apparatus is further caused to receive an indication of a validation of the redemption of the coupon based, at least in part, on the request. The apparatus is further caused to cause, at least in part, modification of representation of the status of the coupon based, at least in part, on the indication of the validation.

According to another embodiment, an apparatus comprises means for causing, at least in part, presentation of a coupon via a device, the presentation including a representation of a status of the coupon. The apparatus further comprises means for, in response to the presentation, generating a request to validate redemption of the coupon, the request including a code. The apparatus further comprises means for receiving an indication of a validation of the redemption of the coupon based, at least in part, on the request. The apparatus further comprises means for causing, at least in part, modification of representation of the status of the coupon based, at least in part, on the indication of the validation.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of validating redemption of a coupon, according to one embodiment;

FIG. 2 is a diagram of the components of a coupon management module, according to one embodiment;

FIG. 3 is a flowchart of a process for validating redemption of a coupon, according to one embodiment;

FIGS. 4A-4G are diagrams of user interfaces utilized in the processes of FIG. 3, according to one embodiment;

FIGS. 5A-5D are diagrams of verification processes involving a user device, a backend server, and a merchant, utilized in the processes of FIG. 3, according to various embodiments;

FIGS. 6A-6D are additional diagrams of verification processes involving a user device, a backend server, and a merchant, utilized in the processes of FIG. 3, according to various embodiments;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for validating redemption of a coupon are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

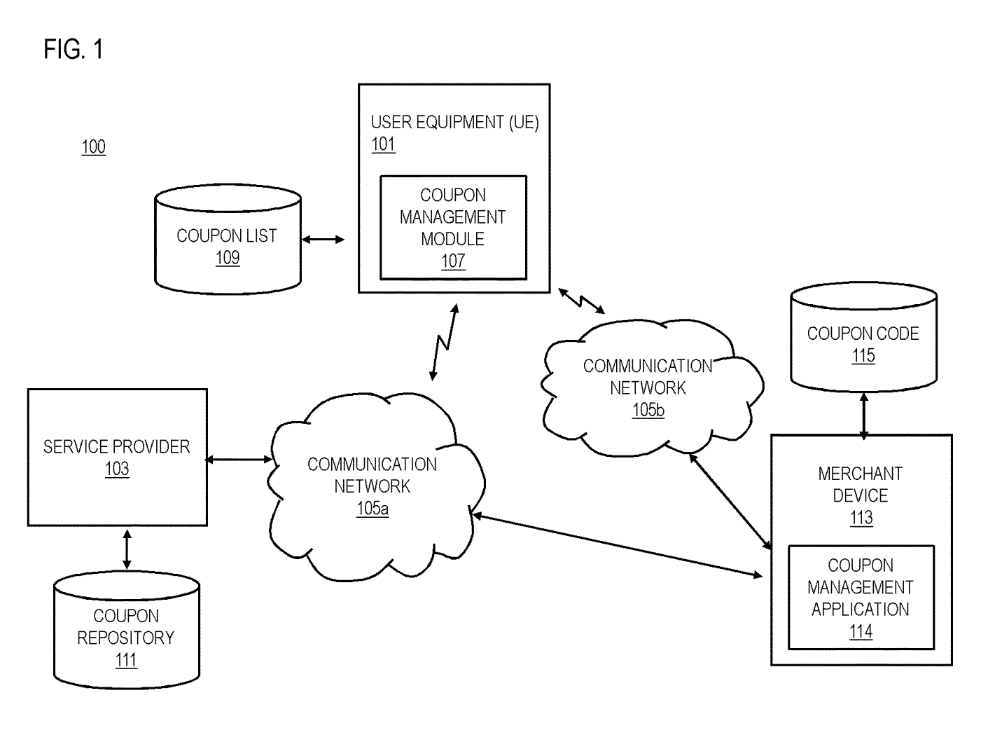

FIG. 1 is a diagram of a system capable of validating redemption of a coupon, according to one embodiment. As discussed previously, the traditional use of a coupon is a paper coupon or a coupon in a physical form. When a merchant or a manufacturer decides to make a promotional offer (e.g. discounts, special deals and etc.), coupons may be distributed via mail, newspaper, magazines as well as internet websites or emails so that the coupons can be printed from the electronic version. When this coupon is presented to a register at a retail store, then the clerk would scan a barcode on the coupon or type in a code to validate the coupon. The clerk can then collect the coupon along with the payment after the coupon is applied.

Managing the use of the coupons and maintaining record of the redemptions may provide benefits, although implementation of such system at a merchant, especially at the retailer's Point of Sale (PoS) system may be difficult. By way of example, maintaining a record of the coupon redemption may enable recording an audit trail, such as the number of coupon redemptions, time/day of the redemption, redemption pattern and rewards, discounts or reconciliations provided by the coupons. Further, if there is a third party involved in the coupon redemption, maintaining a record of the redemption may make it convenient to show the record to the third party. For example, if a manufacturer of an item may issue coupons, and the retailer of the item may need to be reimbursed for giving discounts to the customer who presented the coupon, a record of the coupon redemption would be used as evidence for the reimbursement. Further, without a proper record of coupon redemption, a fraud may occur in coupon uses. For example, an employee may commit fraud by falsely claiming a coupon that a customer never claimed and taking cash from the register. As another example, a coupon may be redeemed more than once per customer (or more than the coupon is meant to be used), or the coupons may be illegally copied and distributed. In some cases, fraudulent users may attempt to modify the terms (e.g., a value) of a coupon and seek to redeem the altered coupon at the merchant.

Managing the coupon redemptions, maintaining the record of the redemptions, and preventing fraudulent use of coupons may be a laborious and time-consuming task if it is performed manually. Therefore, an automation of this task is desired. Because the cash registers and the retail stores in modern days employ electronic devices or small computers, automation of this process may be implemented more easily than before. However, implementation of this system may be time-consuming and costly from a system integration perspective. For example, the retail stores may need to purchase a new hardware to implement this system. Further, this implementation may require development of software for this purpose, which may also be costly.

To address this problem, a system 100 of FIG. 1 introduces the capability to utilize an electronic coupon to validate the coupon securely and to provide a simple and effective way to automatically manage the redemption of the coupons, while avoiding high cost in implementation. More specifically, the system provides an electronic coupon that a user can store in the user's device, and then redeem the coupon when the coupon is used. In one embodiment, the user can present the coupon and/or related contextual data (e.g., coupon code, coupon value, coupon validity date(s), user information, current location, etc.) in the user's device to a merchant or to any other party that may process the coupon for approval. The redemption of the coupon and other information related to the redemption may be stored such that the stored information may be used for managing or bookkeeping. The electronic coupon may request validation for security purposes or to prevent misuse or fraud. In one embodiment, the validation may be performed via a network, wherein the validation is approved via a service provider. In another embodiment, the related contextual data can be used to validate the terms or conditions of a coupon before redemption to avoid, for instance, scenarios where a fraudulent user presents an altered coupon for redemption.

In one embodiment, a user equipment (UE) 101 may store coupons, and may also retrieve coupons. For example, the UE 101 may retrieve coupons from the coupon repository storage medium 111 connected to the service provider 103, or may receive coupons via e-mail updates or other Internet websites. These coupons may be stored in the coupon list 109 connected to the UE 101. Some coupons may be configured such that they can be shared, wherein these sharable coupons may be shared among various user devices. The user can use the coupon by presenting the coupon and/or related contextual data in the UE 101 to a merchant or any other party that may process the coupon. Then, the merchant then may provide a code (e.g., a merchant code, a secure code, etc.) to validate and to redeem the coupon. The merchant code can be generated by, at least in part, a merchant device 113 by employing one or more applications (e.g., a coupon management application 114) operating on merchant information (e.g., merchant name, location, account number, etc.), the contextual data of the coupon and the like. For example, high value coupons (e.g., for merchandise, service, monetary, etc.) may require additional contextual data (e.g., user information) for secure validation, ensure valid usage of the coupon, and to avoid possible fraudulent alterations to the coupon. The contextual data may be presented/submitted by the user and/or the UE 101, in one or more steps, via a manual input, an automatic input, an audio input, a visual input, a wireless input, or a combination thereof.

Additionally, the merchant may have a chart of merchant codes so that the merchant can provide a corresponding merchant code for the coupon to be redeemed. The merchant may obtain the code from the merchant device 113, which can generate and/or store the merchant codes for corresponding coupons in the merchant code storage medium 115 or from the service provider 103. When the merchant code is entered at the UE 101, then the coupon presented via the UE 101 is redeemed, if the entered merchant code is a valid code. The merchant code may be entered at the UE 101 via a manual input, an automatic input, an audio input, a visual input, a wireless input, or a combination thereof. Alter the merchant code is entered, the validity of the merchant code may be determined by the service provider 103 or any other server or device that has proper authority to validate the merchant code. For example, the entered merchant code may be sent to the service provider 103, and the service provider 103 then may send a response including information as to whether the merchant code is a valid code for the presented coupon.

In one embodiment, the validation process may, at least in part, check and/or verify the coupon validity, coupon value, coupon type, authorized user(s) of the coupon, authorized merchant(s) to accept the coupon and the like. If the entered merchant code is valid, the coupon is redeemed via the service provider 103, and a confirmation and/or other indication of the coupon redemption for the UE 101 is transmitted to the UE 101 and may be recorded at the UE 101. Thus, the service provider 103 may work as a server that performs validation and redemption of coupons. However, if one or more parts of the information (e.g., coupon value, validity date(s), merchant account, etc.) used in generating/calculating the merchant code are incorrect and/or invalid; the resulting merchant code can also be incorrect/invalid, which can, at least in part, cause the service provider 103 and/or an authentication service to decline validation of the incorrect/invalid merchant code or can generate/calculate an invalid code (e.g., an error code). Further, information regarding the coupon redemption may be sent to the service provider 103 and/or the merchant device 113, such that the record of the coupon redemptions may be maintained. This process of validation and redemption of coupons may be managed, at least in part, by the coupon management module 107 in the UE 101. Additionally, after the merchant code is validated, a response code may be sent from the service provider 103 to the UE 101. Then, the UE 101 may retrieve the response code and present it to the merchant for verification of the response code. The validation of the coupon redemption may further based on this verification of the response code. The response code provides additional validation in that it may be used to verify whether the service provider 103 is a proper service provider or is otherwise authorized to validate the merchant code.

Further, in another embodiment, a representation showing a status of the coupon may be presented at the UE 101. By way of example, the status may indicate a validity of the coupon, a number of uses of the coupon, previous redemptions, expiration dates, related coupons or redemptions, participating merchant locations, and the like. It is contemplated that the status may indicate any characteristic or parameter associated with the coupon, its redemption, its validation, or a combination thereof. In one embodiment, the representation of the status of the coupon includes one or more geometric figures, colors, images, media files, or a combination thereof. For example, a representation of a valid and previously unredeemed coupon may include a green dot or circle that provides a visual cue that the coupon is valid and can be used.

In one embodiment, presentation of the coupon initiates validation of the redemption coupon as previously described. When the UE 101 receives a confirmation or indication of the coupon redemption from the service provider 103, the representation of the status of the coupon at the UE 101 may be modified to reflect the coupon redemption. For example, a visual characteristic, an audio characteristic, a tactile characteristic, or a combination thereof of the representation of the status of the coupon may be modified to show that the coupon has been redeemed. In the above example of the green dot to indicate a valid coupon, once the coupon has been redeemed, a red dot may be displayed in place of the green dot to indicate that the coupon has already been used and is no longer valid. In another example, a blinking red dot may be displayed to show that information requested for redemption of the coupon (e.g., a merchant code) is either incorrect or needs to be entered.

In another embodiment, the user can cause activation of the coupon management application 114 on the merchant device 113, for example, by activating the coupon management module 107 on the UE 101 which can indicate to the merchant device 113 that the user wishes to utilize on or more coupons in one or more transactions with the merchant. Further, the user can enter/submit a code (e.g., alphanumeric characters) associated with the coupon, the user, the user device and/or other contextual data.

In another embodiment, the merchant can activate the coupon management application 114 and request for the user to enter/submit contextual data about the one or more coupons to be utilized in a transaction. The contextual data may include parameters such as the location, the identity of the clerk, the monetary value of the transaction, a value in a non-monetary space (e.g., number of loyalty points) and the like. In another embodiment, the merchant obtains the contextual data from the user and/or the coupon.

In another embodiment, the merchant can activate the coupon management application 114 and then manually or by data connection from another device (e.g. EPOS Terminal) to the merchant device 113 enter contextual data about the one or more coupons to be redeemed in one or more transactions. The merchant can then ask the user to enter/submit further contextual data. The merchant can also ask the user to enter contextual data into the coupon management module 107 on the UE 101.

In another embodiment, a user can transfer and/or cause transferring of one or more coupons to another user. For example, John has a coupon for a game of golf at a local golf course (merchant) and wishes to transfer the coupon to his friend, Bob. In one scenario, John can forward the coupon and the required information and/or contextual data to Bob so Bob can present the coupon and the required information for validation by the merchant. In another scenario, John can submit Bob's information to the issuer of the coupon so the issuer can send John's coupon to Bob. In another scenario, John can forward the coupon to Bob and provide Bob's information to the issuer and/or the service provider 103 so that Bob can present the coupon to the merchant and validate the coupon with Bob's information.

It is contemplated that the representation of the status may include any available user interface elements or combination of elements including visual elements (e.g., geometric figures, colors, images, etc.), sound or audio elements (e.g., alert tones, audio files, song clips, etc.), tactile elements (e.g., haptic feedback), and the like. This feature is beneficial in that the status of the coupon is easily recognized via the representation of the status of the coupon, especially when there is a limited space to display the coupon and/or the representation of the status of the coupon, and the change in the status of the coupon can also easily be identified via change in a visual characteristic, an audio characteristic, a tactile characteristic, or a combination thereof of the representation of the status of the coupon.

Therefore, an advantage of this approach herein is that the UE 101 causes the service provider 103 to validate the coupon using at least the merchant code such that overuse of the coupons or fraud in use of the coupons may be minimized or prevented, and further verifies the service provider 103 as a proper service provider to validate the merchant code. Another advantage may be that this approach can help maintain record of the coupon uses as well as sales related to the coupons. Therefore, means for validating redemption of a coupon is anticipated.

As shown in FIG. 1, the system 100 comprises a user equipment (UE) 101 having connectivity to a service provider 103 via a communication network 105a. By way of example, the communication network 105a of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

In a preferred embodiment, the UE 101 may be connected to the merchant device 113 via another communication network 105b, wherein the communication network 105b is a short range wireless network or any other form of connection for connecting devices within close proximity. However, in another embodiment, the merchant device 113 may also have connectivity to the UE 101 as well as the service provider 103 via the communication network 105a. In addition, the communication via the communication network 105b may include manual interactions that, in certain embodiments, are supported by visual clues and/or other indicators to facilitate the interactions.

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), audio/video player, digital camera/camcorder, positioning device, television receiver, radio broadcast receiver, electronic book device, game device, or any combination thereof. It is also contemplated that the UE 101 can support any type of interface to the user (such as “wearable” circuitry, etc.). The UE 101 may also include input means such as keyboards, touch pads, touch screen buttons, clickable buttons, and etc., for entering code or commands.

By way of example, the UE 101, the service provider 103 and the merchant device 113 communicate with each other and other components of the communication networks 105a and 105b using well known, new or still developing protocols. In this context, a protocol includes a set of rules defining how the network nodes within each of the communication networks 105a and 105b interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model. In one embodiment, the communication protocol via the communication network 105b may be made simpler than the communication protocol via the communication network 105a. This is because the communication between the merchant device 113 and the UE 101 may be simpler than the communication between the service provider 103 and the UE 101.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

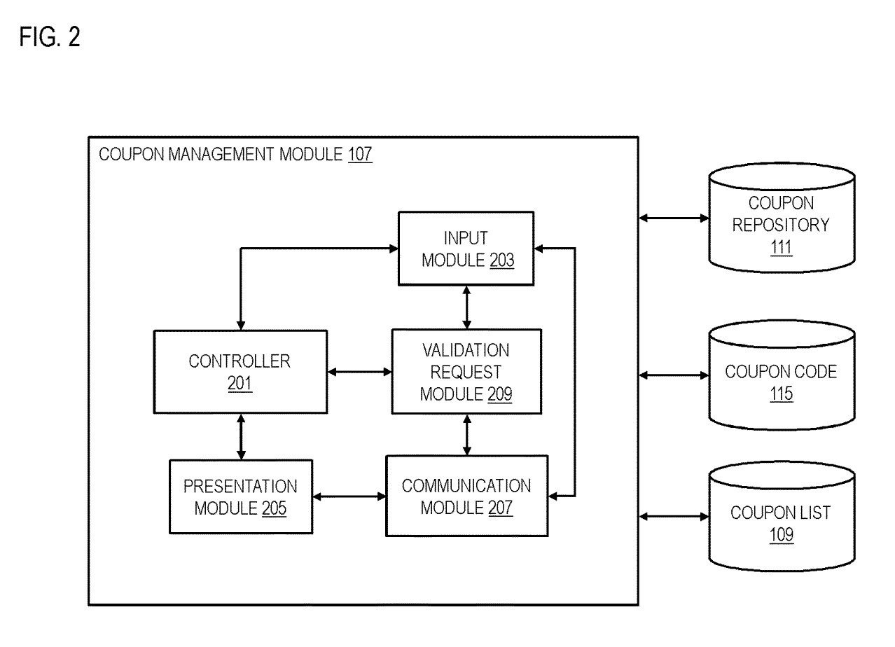

FIG. 2 is a diagram of the components of the coupon management module 107, according to one embodiment. By way of example, the coupon management module 107 includes one or more components to perform validation for redemption of a coupon. It is contemplated that the functions of these components may be combined in one or more components or performed by other components of equivalent functionality. By way of example, the coupon management module 107 includes one or more components for managing an inventory and sales of items. It is contemplated that the functions of these components may be combined in one or more components or performed by other components of equivalent functionality. In this embodiment, the coupon management module 107 includes a controller 201 for controlling flow of information into and out of the UE 101 and within the UE 101, an input module 203 for managing input or data acquired into the UE 101, a presentation module 205 for gathering information to display on an interface, a communication module 207 for performing communication into and out of the UE 101 as well as within the UE 101, a validation request module 209 for requesting validation of coupons for coupon redemption. The controller 201 oversees tasks, including tasks performed by the input module 203, the presentation module 205, the communication module 207 and the validation request module 209.

More specifically, the input module 203 may be configured to receive an input at the UE 101 for entering a merchant code and retrieving a coupon or a merchant code. The input module 203 may communicate with the communication module 207 to submit a merchant code to the service provider 103 for validation. For example, when the user wants to redeem the coupon and the merchant provides a merchant code, the user of the UE 101 may submit the merchant code via the communication module 207 to the service provider 103 for validation. The input module 203 may also communicate with the communication module 207 to retrieve a coupon from the service provider 103 or to receive a merchant code from the merchant device 113. The input module 203 may also be used to enter any information or commands necessary to retrieve a coupon and to validate the coupon.

The validation request module 209 is involved with a validation process to validate a coupon that the user desires to redeem. The validation request module 209 may transmit via the communication module 207 a request to validate the redemption of the coupon based on a merchant code. For example, the validation request module 209 may generate a request including the merchant code to redeem the coupon, and transmit this request to the service provider 103 via the communication module 207. The service provider 103 then can validate the code with respect the coupon, and transmit an indication of validation to the UE 101. Then, the validation request module 209 processes this validation and displays the indication of the validation of the coupon at the UE 101 via the presentation module 205. This indication of the validation of the coupon displayed at the UE 101 may be presented to the merchant so that the merchant can verify and process the coupon.

The communication module 207 may be used to retrieve coupons and information related to the coupons from a coupon source such as the service provider 103, to submit a merchant code to the service provider 103 and to communicate validation of the coupons with the service provider 103. The communication module 207 may also be used to receive a merchant code from the merchant device 113. Further, the communication module 207 may be used to receive the response code from the service provider 103, and may also be used to transmit the response code from the UE 101 to the merchant device 113, for verification of the response code. The communication module 207 may also be used to receive advertisements from the service provider 103 or the merchant device 113. Hence, the communication module 207 is used to manage any form of information exchange between the UE 101 and the service provider 103 and/or the merchant device 113. The communication module 207 may include two separate communication modules, one communication module for communication between the UE 101 and the service provider 103 and the other communication module for communication between the UE 101 and the merchant device 113. More specifically, if there are two communication networks 105a and 105b, one communication module may be used for connectivity via one communication network 105a while the other communication module may be used for connectivity via the other communication network 105b.

The presentation module 205 displays various user interfaces to display information such as coupons, options to redeem coupons, statuses of the coupons, validation option, and etc. The presentation module 205 may also display representations related to the items subject to the coupons, and any content retrieved from the service provider 103 and/or the merchant device 113. The presentation module 205 may also present the information in an audio or a tactile form.

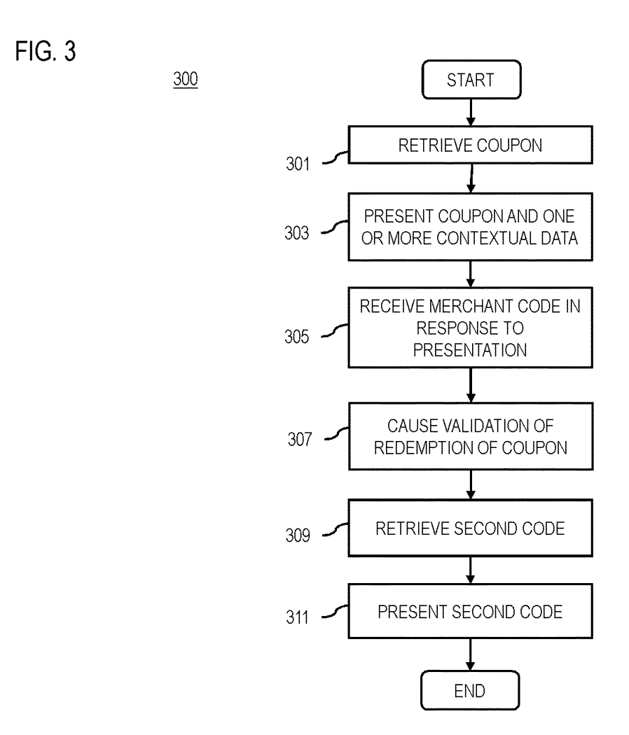

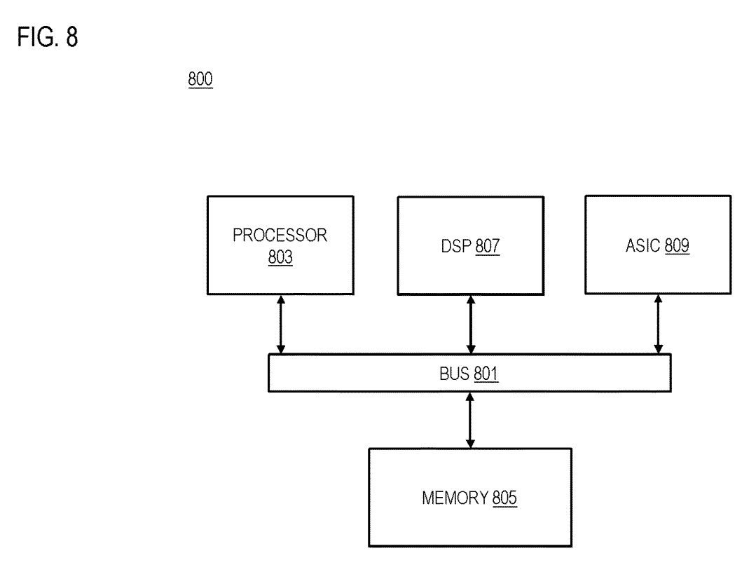

FIG. 3 is a flowchart of a process for validating redemption of a coupon, according to one embodiment. In one embodiment, the coupon management module 107 performs the process 300 and is implemented in, for instance, a chip set including a processor and a memory as shown in FIG. 8. In step 301, the coupon management module 107 retrieves a coupon at the UE 101, wherein the coupon may be used at the merchant or any other places that can realize the value of the coupon. The coupon may be retrieved from the service provider 103 or the merchant device 113. The service provider 103 may be a server managed by a brand or a manufacturer of the item or the merchant for which the coupon may be used, or also may be managed by an independent third party. Further, the service provider 103 may be a service dedicated to distributing coupons. The coupon management module 107 may have the UE 101 display the retrieved coupons. In step 303, the user may present the coupon and one or more contextual data (e.g., coupon code, coupon value, coupon validity date(s), user information, current location, etc.) using the UE 101, wherein the coupon may be presented to the merchant or any other party that can realize the value of the coupon. The merchant can then see and/or receive the presented coupon and the one or more contextual data, and provide the user with a first code, such as a merchant code, which may be used for validation of the coupon for coupon redemption. In one embodiment, the first code (e.g., merchant code) is generated/calculated by the coupon management application 114 utilizing one or more contextual data such as a coupon code, coupon value, coupon validity date(s), user information, current location, merchant name, merchant account number, and the like. The inclusion of the contextual data in the generation/calculation of the first code (merchant code) ensures valid usage of the coupon and reduces/eliminates possible fraudulent alterations to the coupon. For example, if one or more parts of the contextual data (e.g., coupon value) is altered (e.g., “2 for 1” changed to “4 for 1”), then the first code generated/calculated (e.g., based on “4 for 1”) would be different than the one generated/calculated (e.g., based on “2 for 1”) by the service provider 103 (or an alternate validating authority) causing a rejection of the coupon by the service provider 103. The presentation of the coupon may further include a sign or an indication showing a validity status, a redemption status of the coupon or a combination thereof. The type of the merchant code may include a one-time passcode, a secure passcode, a token-based passcode, a signed passcode and an encrypted passcode. The merchant code may be specific to the merchant, a representative of the merchant, a sales terminal of the merchant, the coupon, a type of the coupon, or a combination thereof.

In step 305, the coupon management module 107 receives the first code from the merchant in response to the presentation of the coupon. The coupon management module 107 may receive the code (e.g., the merchant code) directly from the merchant, who can show the merchant code or read the merchant code to the user so that the user can enter the merchant code into the UE 101. The user may manually enter the code into the UE 101 (e.g., manual input) or the code may be automatically entered into the UE 101 (e.g., an automatic input) as the code is transmitted to the UE 101. For example, the coupon management module 107 may also receive the merchant code directly at the UE 101 from the merchant device 113 via the communication network 105b, using a short message service (SMS), a multimedia messaging service (MMS), a voice service, a network connection including a wireless network connection, any other form of network communication, or a combination thereof. In another example, the input may be entered at the UE 101 in a form of an audio input (e.g., a coded audio signal, voice recognition, etc.) or a visual input (e.g., a barcode, image recognition, etc.). Thus, the code may be received at the UE 101 via a manual input, an automatic input, an audio input, a visual input, a wireless input, or a combination thereof. The connectivity provided by the communication network 105b may be dedicated for communication within close proximity, and may be provided by a radio-based communication such as Bluetooth®. Then, as shown in step 307, the coupon management module 107 causes a validation of redemption of the coupon based on the merchant code. For example, the coupon management module 107 may transmit the merchant code to a server such as the service provider 103 and have the service provider 103 validate the merchant code. In another example, the coupon management module 107 may validate the merchant code within the UE 101. If the connectivity is not available between the UE 101 and the service provider 103, due to poor reception or other circumstances, then the coupon management module 107 may check locally in the UE 101 whether there is sufficient information to validate the merchant code within the UE 101 (e.g., by checking any cached merchant codes). If there is sufficient information in the UE 101 to validate the merchant code, then the coupon management module 107 may use this information to validate the redemption of the coupon based on the merchant code. Then, any other information related to the coupon validation, such as the time of transaction, the amount involved in the transaction, and etc, may be stored locally in the UE 101. This stored information may then be sent to the service provider 103 to maintain a record of the coupon redemption when connectivity (e.g., over the communication network 105b) with the service provider 103 becomes available. In addition or alternatively, the UE 101 may send the information using an alternative means of communication such as SMS, e-mail, and the like. The coupon management module 107 may receive and display the result of the validation of the merchant code. In one embodiment, a single coupon may also have multi-level validation, wherein each level has its own validation and its own deals or promotions. Accordingly, the user may enter merchant codes corresponding to the multiple levels. The promotions corresponding to the valid merchant code associated with the corresponding level within one coupon may then be applied at the retail store.

Next, a backend server such as the service provider 103 may also be authenticated by using a second code, such as a response code. Thus, in step 309, the coupon management module 107 may retrieve the second code based on the coupon, the first code or a combination thereof. This provides additional security to check whether the UE 101 is connected to a proper server for validating the merchant code. When the UE 101 sends the merchant code to the service provider 103, the service provider 103 may provide the UE 101 with the response code. Further, the service provider 103 generates/calculates the response code for the first code received from the user and if the two codes do not match, the service provider 103 can reject the validation request and can send the response code indicating the rejection (e.g., can indicate “error in first code”, “invalid first code”, “invalid merchant code”, etc.). Then, as shown in step 311, the response code may be presented to the merchant or any other party that can verify the response code. For example, the merchant can enter the response code at the merchant device 113 to verify the response code. The merchant code may be manually entered by the merchant, or may be automatically transmitted to the merchant device 113. Thus, in order to completely validate the coupon, both the merchant code and the response code may need to be validated and/or verified. Alternatively, the coupon may be validated with the merchant code only, and the response code may be used as a code to ensure that the validation of the coupon is proper. The response code may include a check code, a secure code and a bar code.

The coupon may be automatically redeemed as soon as the coupon is validated. Alternatively, the UE 101 may ask the user again whether to redeem the coupon or present other options, upon validation of the coupon. On the contrary, if the coupon is not validated, then the coupon may not be redeemed. The redemption status of the coupon showing whether the coupon has been redeemed is transmitted to the UE 101. This redemption status of the coupon may be displayed on the UE 101. Then, the user may present the redemption to the merchant such that the merchant may apply the coupon. The redemption of the coupon may be communicated to a sponsor of the coupon such that the coupon benefits may be distributed from sponsors of the coupon to the merchant. For example, if the coupon sponsor is a manufacturer and the coupon benefit is $1.00 off a regular price, then upon the redemption of the coupon, the coupon sponsor may reimburse the merchant with the $1.00. Further, upon redemption of the coupon, information related to the coupon may be stored in the service provider 103 or the UE 101 or the merchant device 113 or a combination thereof. For example, a log of transactions with respect to the coupon, the merchant, the device or a combination thereof may be stored, as the coupon is redeemed. This stored information may also be transmitted to a merchant (e.g. to the merchant device 113), such that the merchant may access this information for bookkeeping purposes.

In one embodiment, the coupon management module 107 may generate a request to redeem the coupon, wherein the request includes the merchant code. This request may be sent to the service provider 103, which then determines whether to validate the coupon or not, based on the merchant code. If the service provider 103 validates the coupon, the indication of the validation may be transmitted to the UE 101, so as to show that the coupon has been validated. The indication of the validation and redemption transmitted to the UE 101 may change the display of the coupon status, depending on whether the coupon has been validated and redeemed. The indication may be in a form of geometric figures or different colors, or a combination thereof.

The code used as a validation code (e.g. a merchant code or a response code) in this approach may be in a form of a Simple Code. This code may be constant for the life of the coupon, and may employ a 4-digit numeric code. Therefore, this is useful to use a code that is constant, particularly if the UE 101 is used in an offline setting (i.e. without being connected to the service provider 103), because the validation information for the Simple Code may be stored within the UE 101 to be used as information to validate the code such as the merchant code. Then, until the UE 101 goes online, the UE 101 may store information about transactions occurred during validation of the code as well as information regarding redemption of the coupon, and this information is transmitted to the service provider 103 when the UE 101 goes online, at least for bookkeeping purposes. The Simple Code may be defined by the merchant, and may be used for redemption of the coupon. Further, the Simple Code may be used for all of the coupons. The Simple Code may be associated with the redemption point (i.e. the point or the location where the coupon redemption occurred), such as a retailer location. If all the coupons are generated by one retailer, then each coupon's redemption point is the location of the retailer. Then, the Simple Code may be used as an employee ID to track who redeemed the coupon.

Additionally or alternatively, this approach may also utilize the Secure Code as the validation code and may utilize a service provider 103 communicating with the UE 101 to validate the Secure Code. The validation code such as the merchant code or the response code may include the Secure Code, and may further include an ID (identification) part. The ID part may define a mechanism (e.g. a Secure Code generator) used to generate the Secure Code, and may be in a form of metadata. The ID part may be integrated in the coupon itself, or the ID part may be integrated as a part of the code communicated from the merchant to the service provider 103. The Secure Code part may a one-time-pass-code (OTPC) part that may be generated using a Secure Code generator such as a one-time-pass-code (OTPC) generator, which may be connected to the merchant device 113 or embedded within the merchant device 113. Thus, the merchant code communicated to the service provider 103 for validation may have the ID part and the Secure Code part, including three to six digits of alphanumeric characters, wherein the number of digits may be variable, for example. The service provider 103 or the merchant or the coupon issuer may choose between a high convenience/low security option (less digits) and a low convenience/high security option (more digits). In one example, the ID part may have a code defining the merchant or the brand or the manufacturer of the item on sale or the Secure Code generator itself, and the ID part may not be constantly changing. Then, the Secure Code part may be constantly changing depending on factors such as time. The Secure Code part may include a code defining a redemption point or an employee ID or a cash register ID. The code in the Secure Code part may allocate digits in the code to different parameters. For example, for a 6-digit Secure Code, 3 digits may be allocated to define the brand and 3 digits may be allocated to define the redemption point.

In one embodiment, coupon redemption may be used to promote a customer loyalty. For example, this approach may enable the user to get a free meal if the user eats at the same restaurant for five times. In this example, the user may redeem the loyalty coupon by entering the merchant code every time the user eats at the restaurant. Then, the frequency of the user getting meals at the restaurant may be tracked by redemption of a loyalty coupon via the merchant code.

In one embodiment, the OTPC-tokens that periodically produce a new code in every predetermined time period may be used for a secure code for the merchant code and/or the response code. The OTPC-token may be also generated when the user requests the next code. Further, the secure code may be a sequence of alphanumeric characters generated by an algorithm, or may also be a Hash-based Message Authentication Code (HMAC). If the OTPC-token is used, the merchant may have an OTPC-token that can provide a set number of digits. For example, for a coupon, the merchant may have a 6-digit OTPC-token, wherein 3 digits are provided as a merchant code to the user for a merchant verification at the service provider 103, and the service provider 103 returns 3 digits as a response code, which are verified with the remaining 3-digits for the 6-digit OTPC-token. In another example, the merchant may provide the first 6-digit number to the user, such that the user may use this 6 digit number for the merchant verification. Then, another 6 digits are returned by the service provider 103 and are compared with the next 6 digits produced by the HW OTPC-token, for server verification, wherein the next 6 digits correspond to the first 6-digits. Yet, in another example, the merchant OTPC-token may provide a 6 digit number to the user, such that the user may use this 6 digit number for the merchant verification. Another 6 digits are then returned by the server, and are entered into the merchant OTPC-token using a local keyboard. Using a comparison algorithm, the 6 digits returned by the server are compared with the next 6 digits produced by the HW OTPC-token, for server verification, and then produce a True/False results depending on the comparison result.

This process is advantageous in that it provides a way to validate using the UE 101 the coupon based on validation of the merchant code corresponding to the coupon. This process may also provide additional advantage in that it provides a way to validate using the UE 101 the service provider 103. Thus, this process prevents any overuses or fraud that may occur with paper coupons. Additionally, this process can maintain record of the coupon uses and sales, at least for bookkeeping purposes. The coupon management module 107 is a means for achieving this advantage.

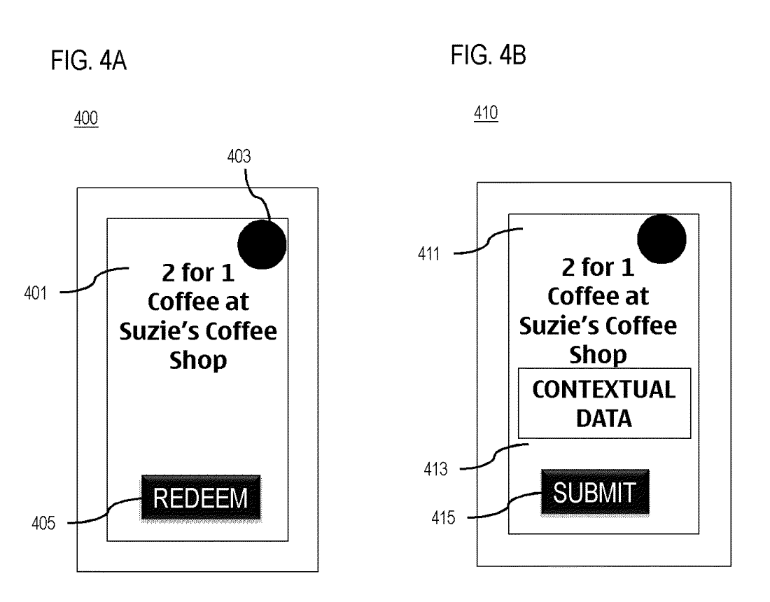

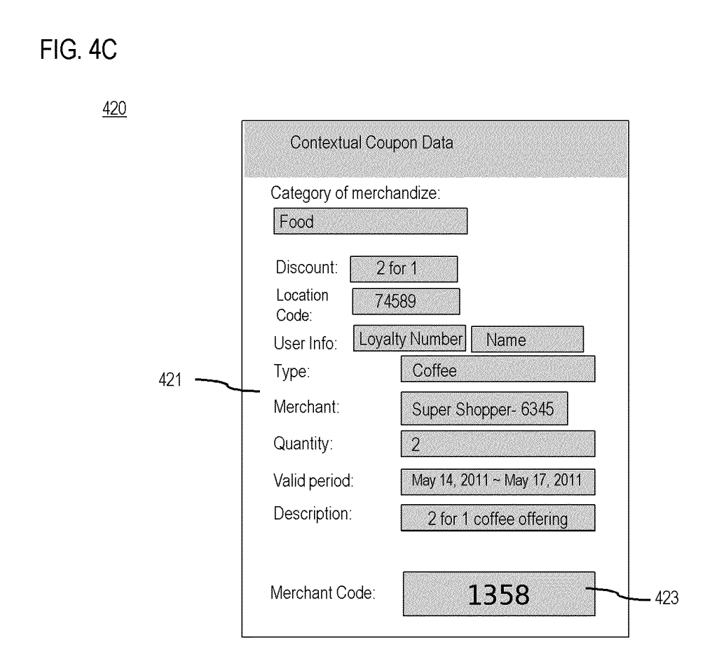

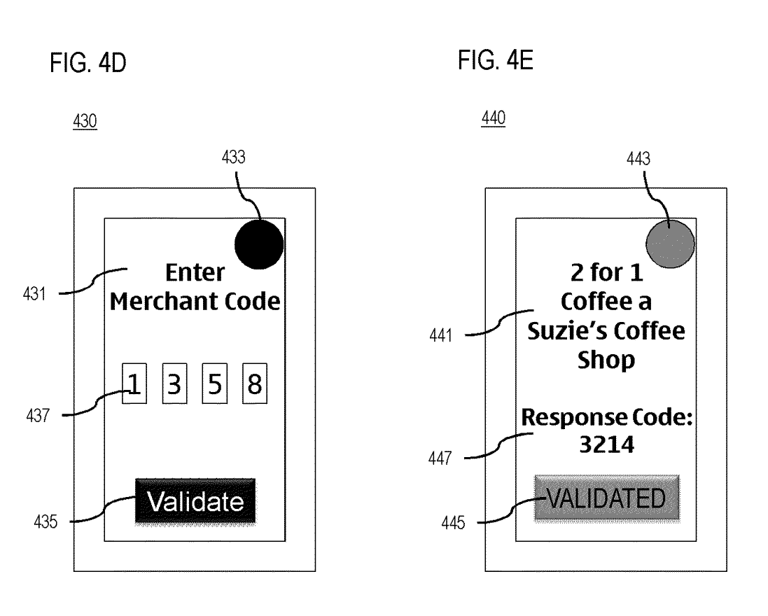

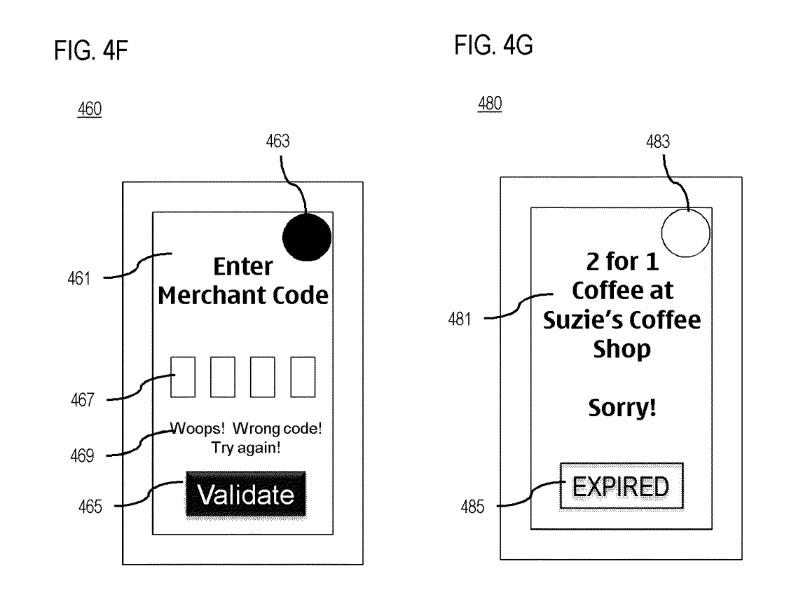

FIGS. 4A-4G are diagrams of user interfaces utilized in the processes of FIG. 3, according to one embodiment. FIG. 4A shows an user interface 400 shown in the UE 101 with a coupon for Suzie's Coffee Shop. The main screen 401 displays a coupon on the UE 101 showing a special deal that the coupon offers for Suzie's Coffee Shop. The indicator dot 403 is in black, showing that the coupon has not been completely redeemed or used. When the user of the UE 101 uses the coupon 401 at the Suzie's Coffee Shop, the user may present the coupon 401 to the clerk of the Suzie's Coffee Shop. Then, the clerk may have the user selects the Redeem option 405 to redeem this coupon 401. When the user selects the Redeem option 405, the user interface 411 of FIG. 4B will be displayed whereby the user and/or the UE 101 can submit at 415 (e.g., via coupon management module 107), substantially automatically and/or manually, contextual data 413 to the merchant and/or the merchant device 113. The contextual data, at least in part, may include data about the value of the coupon (e.g., “2 for 1”, “15% discount”, etc.), one or more participating merchants, location of the one or more participating merchants, one or more validity dates of the coupon, intended user of the coupon (coupon assignee), user loyalty account number, and the like.

In one embodiment, the user, at least in part, submits the contextual data; for example, the user utilizes one or applications on the UE 101 to collect and/or submit the contextual data via the communication network 105b to the merchant device 113. In another embodiment, the UE 101, at least in part, collects and/or submits the contextual data; for example, the UE 101 (e.g., via one or more applications on the UE 101) communicates (e.g., via the communication network 105b) with the merchant device 113 (e.g., the merchant device 113 requests one or more specific contextual data) and submits the contextual data. Further, the merchant device 113 may contain and/or have access to a list of contextual data necessary when one or more coupons are to be redeemed and/or validated. Furthermore, the one or more coupons may indicate, at least in part, to the user, to the UE 101 and/or to the merchant device 113 the one or more contextual data necessary for redeeming and/or validating the one or more coupons. Moreover, type and/or value of a coupon may require different and/or additional contextual data. For example, a coupon for a weekend stay at a resort (e.g., high value) may require the user to present valid user identification (e.g., physical and/or electronic), loyalty account number, supervisory approval at the merchant location, and the like.

FIG. 4C shows an example user interface 420 of the merchant device 113 wherein the contextual data 421 can be captured and processed (e.g., for generating/calculating a merchant code). As shown in the FIG. 4C example, the contextual data may contain one or more information related to the coupon, the user, merchant, type of merchandise/service, validity period, quantity, and the like; one or more of which can be utilized in generating the merchant code at 423 (e.g., 1358 in this example). In one embodiment one or more contextual data may be, at least in part, collected, submitted and/or transferred by the user to the merchant device 113 via the UE 101 and/or the merchant device 113. In another embodiment, the one or more contextual data may be, at least in part, collected, submitted and/or transferred by the merchant (e.g., a clerk) to the merchant device 113. In another embodiment, the UE 101, at least in part, may collect, submit and/or transfer the one or more contextual data to the merchant device 113; for example, if it is determined that one or more coupons are to be redeemed, the user, the UE 101, the merchant, and/or the merchant device 113 can cause the UE 101 to, substantially automatically, present (e.g., collect, submit, transfer, etc.) the one or more contextual data to the merchant and/or to the merchant device 113 required for the one or more coupon redemptions.

Once the user, UE 101 and/or the merchant collect/submit the contextual data, in FIG. 4D, the coupon management module 107 and/or one or more applications on the UE 101 may request that a merchant code (e.g., a first code) be entered. The clerk may provide a merchant code to validate the coupon 401. In one embodiment, the merchant device 113 (e.g., via the coupon management application 114 and/or one or more applications) may utilize, at least in part, the contextual data and other coupon information for generating/calculating the merchant code (e.g., a first code). For example, the merchant code can be generated/calculated (e.g., via an algorithm, a hash code, etc.) such that it includes valid information (e.g., about a coupon and/or a user) required by the service provider 103 for validating the coupon wherein the service provider 103 can access substantially same method (e.g., via the algorithm, the hash code, etc.) for decoding and/or deciphering the merchant code such that it can ascertain information about the coupon, the user, validity of the coupon, and the like.

In this example, the main screen 431 shows the “Enter Merchant Code” screen with slots 437 for the merchant code. The user may enter the merchant code using a key pad (not shown). When the user has entered the merchant code, then the user may select the Validate option 435 to validate the merchant code for the coupon. The indicator dot 433 is still in black because the coupon has not been completely redeemed or used. When the merchant code has been entered and the Validate option 435 is selected, the coupon management module 107 communicates with the service provider 103 to determine whether the merchant code is valid or not. If the entered merchant code is valid, then the user interface 440 shown in FIG. 4E may be displayed to show that the coupon has been validated. FIG. 4E displays the coupon 441. Then, the indicator dot 443 is in gray to indicate that the coupon 441 has been validated or redeemed or used. The option 445 shows that the coupon has been validated, by showing the text “VALIDATED.” Further, in response to the validation of the merchant code, the service provider 103 may provide a response code (e.g., a second code), as shown in the response code portion 447 of the user interface 440. Then, this response code may be presented to the merchant for verification of the response code, to further validate the coupon.

If the entered code is not valid, then the user interface 460 as shown in FIG. 4F is displayed to allow the user another chance to enter a valid code. The main screen 461 shows the “Enter Merchant Code” screen with slots 467 for the merchant code. In this user interface, the status indicator 469 shows that a wrong code has been entered. The slots 467 have been cleared because an invalid code has been entered previously. The user may enter a code into the slots 467 using a keypad (not shown) and then press the Validate option 465 to try to redeem the coupon again. The indicator dot 463 is still in black in this case because the coupon has not been redeemed or used. If a valid code is entered, then the user interface shown in FIG. 4E will be displayed. If the entered code is invalid again, then the user interface shown in FIG. 4F will be displayed so that the user can try to enter the code again. FIG. 4G shows the user interface 480 if the coupon selected for display or redemption has been expired. The main screen 481 shows the coupon and displays the message “Sorry!” indicating that this coupon is not valid. The indicator dot 483 is in white, indicating that the coupon is not valid. The option 485 also displays that the coupon has been expired 485.

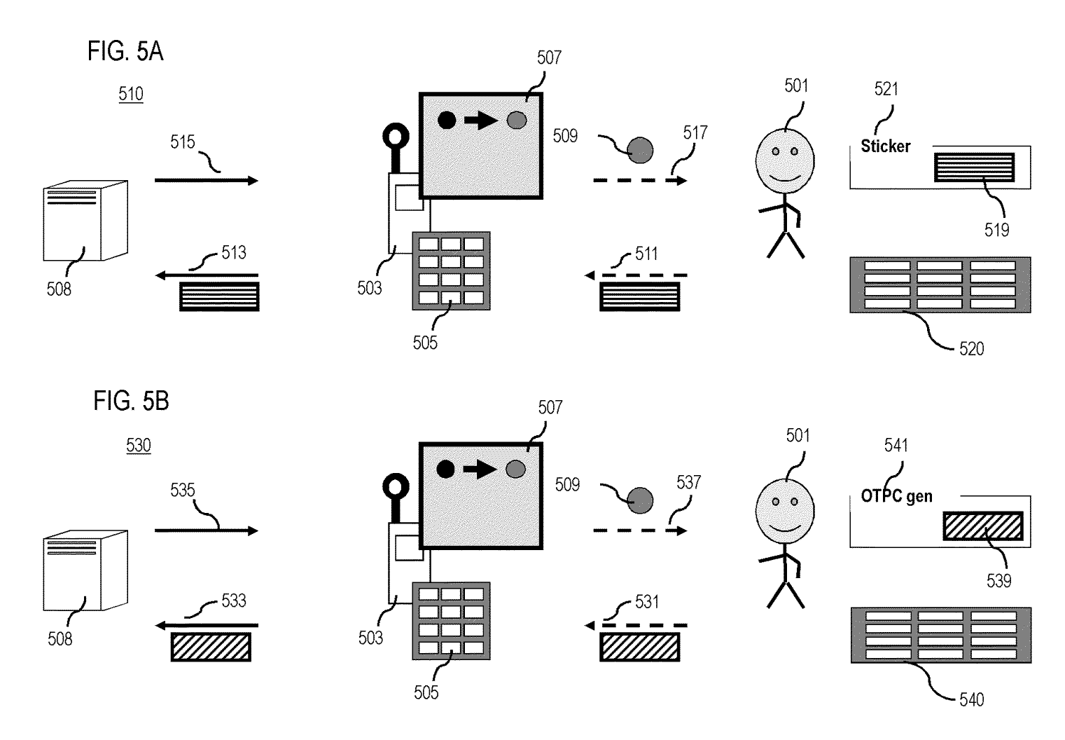

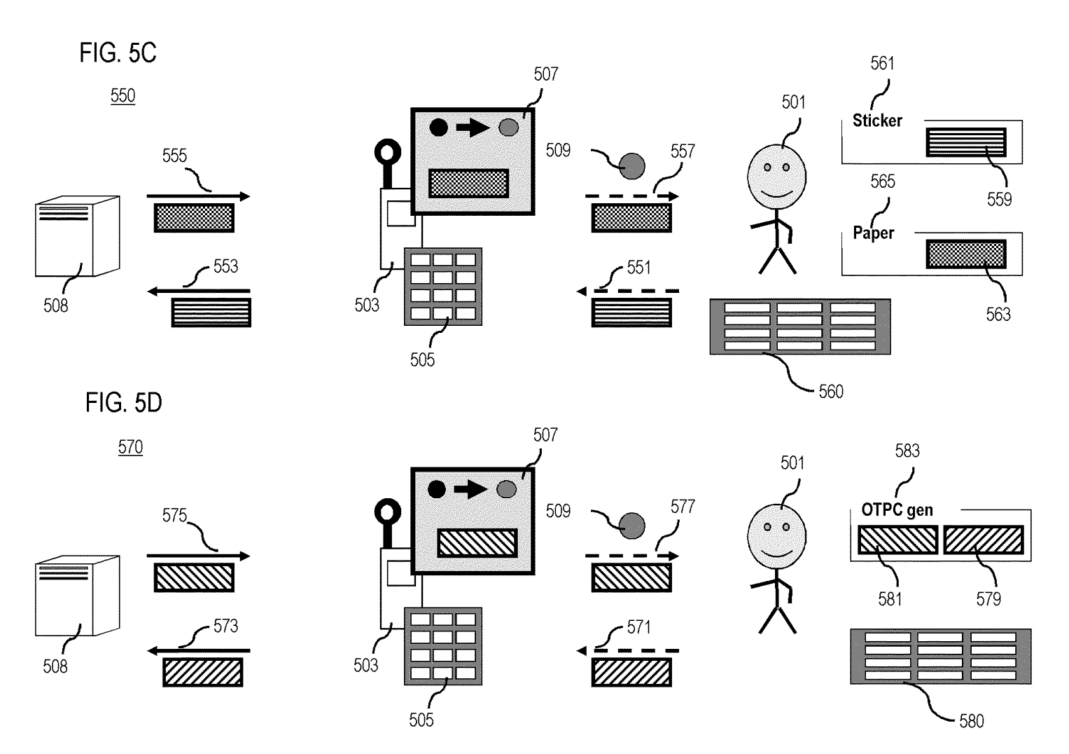

FIGS. 5A-5D are diagrams of verification processes involving a user device, a backend server, and a merchant, utilized in the processes of FIG. 3, according to various embodiments. In the process 510 shown in FIG. 5A, the merchant 501 reads a merchant code for a coupon, from a sticker 521 corresponding to the coupon, as shown in step 511. In FIG. 5A, the simple code 519 is used as the merchant code. In another embodiment, the simple code 519 and contextual data 520 from the user and/or the UE 101 (e.g., via one or more applications) are utilized in generating/calculating the merchant code (e.g., first code). Then, the user enters the merchant code into the key pad 505 on the user device 503 (e.g. the UE 101), and the user device 503 sends the merchant code to the backend server 508 (e.g. the service provider 103), as shown in step 513. The backend server 508 verifies the merchant code, and then sends an indication that the code has been verified, as shown in step 515. If the entered code is a valid merchant code, then a black indication dot changes into a gray indication dot to indicate that the merchant code is valid, as shown in the display screen 507. In step 517, the user shows the gray indication dot 509 to the merchant 501. Then, the merchant 501 approves the coupon, and processes according to the coupon. The process 530 in FIG. 5B shows a process similar to the process in FIG. 5A, except that a secure code 539, which may include contextual data 540, generated by the OTPC 541 is used, at least in part, as the merchant code instead of the simple code 519 and the contextual data 520. Thus, in FIG. 5B, step 531, step 533, step 535 and step 537 are the same as step 511, step 513, step 515 and step 517, except that the secure code 539 is used as a merchant code, instead of the simple code 519 which may include the contextual data 540.

In the process 550 shown in FIG. 5C, step 551 and step 553 are the same as step 511 and step 513 of FIG. 5A in that, at least in part, the simple code 559 from the sticker 561 and the contextual data 560 are used as the merchant code to be verified at the backend server 508. Then, when the merchant code is verified at the backend server to be a valid code, in step 555 a check code as a response code is sent from the backend server 508 to the user device 503 along with an indication that the code has been verified. In step 557, the user shows the gray indication dot 509 to the merchant 501 as a sign that the merchant code is valid and also presents the check code to the merchant 501. Then, the merchant can verify the check code by comparing with the check code 563 from the paper 565. In the process 570 shown in FIG. 5D, step 571 and step 573 are identically to step 531 and step 533 of FIG. 5B in that, at least in part, the secure code 579 and contextual data 560 are used as the merchant code to be verified at the backend server 508. Then, in step 575 another secure code as a response code is sent from the backend server 508 to the user device 503 along with an indication that the code has been verified. In step 577, the user shows the gray indication dot 509 to the merchant 501 as a sign that the merchant code is valid and also presents the secure code to the merchant 501. Then, the merchant can verify the secure code by comparing with the code generated by the OTPC generator 583. In FIG. 5D, the OTPC code generated by the OTPC generator 583 has, at least in part, a merchant code portion 579, contextual data 580, and the response code portion 581.

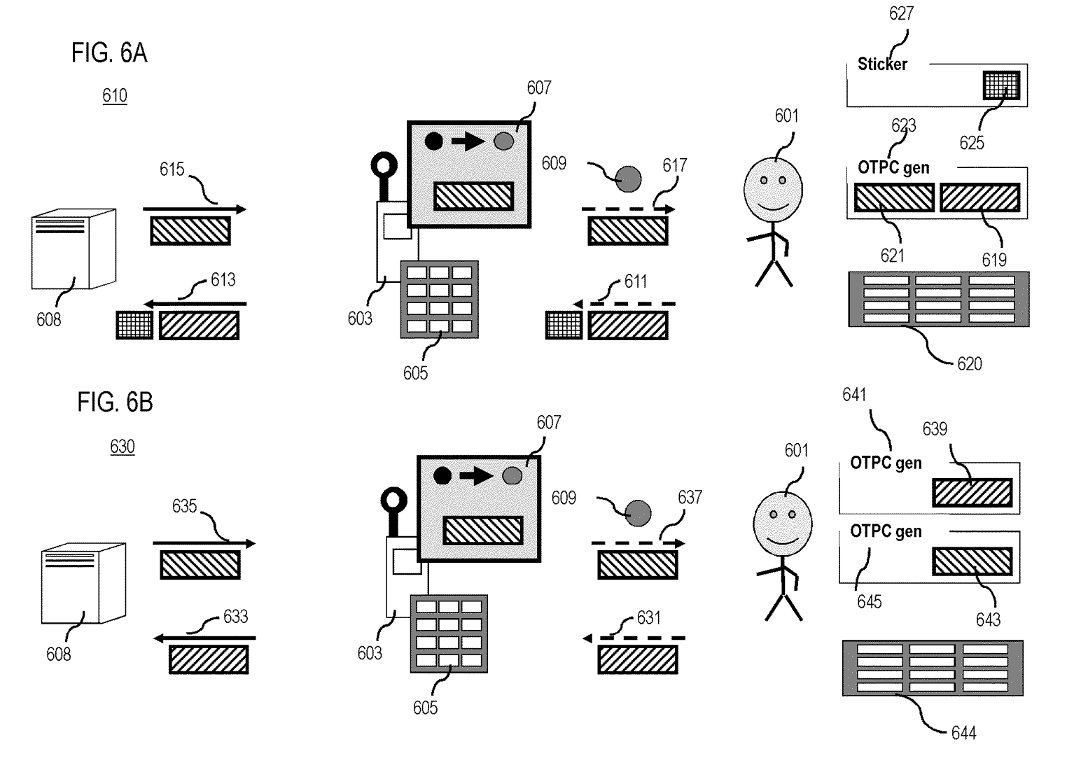

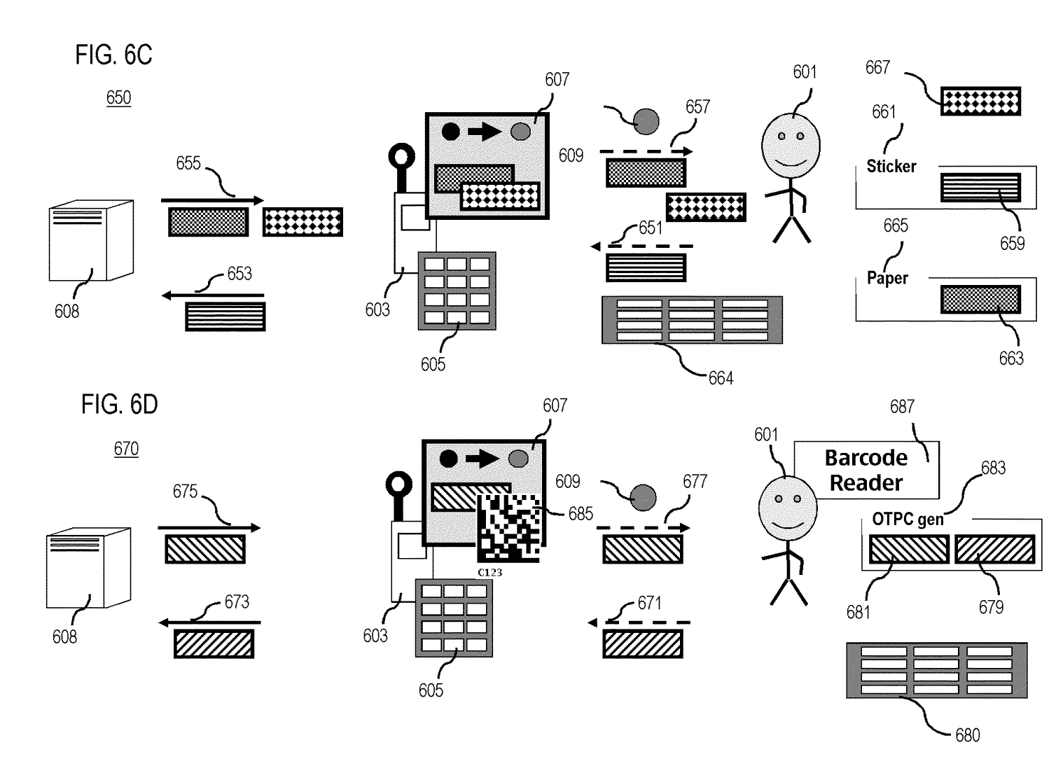

FIGS. 6A-6D are additional diagrams of verification processes involving a user device, a backend server, and a merchant, utilized in the processes of FIG. 3, according to various embodiments. The process 610 in FIG. 6A shows a process similar to the process in FIG. 5D, except that an ID generated by the OTPC is used as a part of the merchant code. Thus, in FIG. 6A, the merchant 601 presents a merchant code for a coupon, wherein the merchant code includes the ID 625 from the sticker 627, a merchant code portion 619 and contextual data 620 of the secure code from the OTPC generator 623, as shown in step 611. Then, the user enters the merchant code into the key pad 605 on the user device 603 (e.g. the UE 101), and the user device 603 sends the merchant code to the backend server 608 (e.g. the service provider 103), as shown in step 613. After the merchant code is verified at the backend server 608, step 615 and step 617 of FIG. 6A are identical to step 575 and step 577 of FIG. 5D in that the backend server 608 sends another secure code as a response code, to be verified by the merchant 601 against the response code portion 621 of the secure code. The process 630 in FIG. 6B is similar to the process in FIG. 5D, except that the merchant code portion 639, including contextual data 644, is one set of OTPC code and the response code portion 643 is another set of OTPC code in FIG. 6B, whereas the process in FIG. 5D shows that both the merchant code portion 579 and the response code portion 581 are within one set of OTPC code. The merchant code portion 639 may be generated by one OTPC generator 641 and the response code portion 643 may be generated by another OTPC generator 645. Alternatively, although not shown, both the merchant code portion 639 and the response code portion 643 may be generated by the same OTPC generator. Except for this difference, step 631, step 633, step 635 and step 637 of FIG. 6B are the same as step 571, step 573, step 575 and step 577 of FIG. 5D.

The process 650 in FIG. 6C is similar to the process in FIG. 5C, except that a promotion code 667 is generated by the backend server 608 to be presented to the merchant 601. In FIG. 6C, step 651 and step 653 are the same as step 551 and step 553 of FIG. 5C in that the simple code 659 from the sticker 661 and contextual data 664 are used as the merchant code. Then, when the merchant code is verified at the backend server 608 to be a valid code, in step 655 a check code 663 as a response code and the promotion code 667 are sent from the backend server 608 to the user device 603 along with an indication that the code has been verified. In step 657, the user shows the gray indication dot 609 to the merchant 501 as a sign that the merchant code is valid and also presents the check code to the merchant 501. Then, the merchant 601 can verify the check code by comparing with the paper 665, and process the promotion code 667 as well. Further, although not shown in this figure, the promotion code may also be a part of the original coupon metadata.

The process 670 in FIG. 6D is similar to the process in FIG. 5D, except that a bar code 685 (two-dimensional or three-dimensional) is produced by the user device 603 based on the response code and is presented to the merchant 601, such that the merchant can read the bar code 685 with a barcode reader 687 and compare the read bar code with the response code portion 681 at the OTPC generator 683. In FIG. 6D, step 671, step 673 and step 675 are identical to step 571, step 573 and step 575 of FIG. 5D in that the merchant code portion of the secure code 679 and contextual data 680 are used as the merchant code to be verified at the backend server 608, and the response code portion of the secure code 681 is used as the response code. Then, in step 677, the user device 603 produces a bar code 685 based on the response code received from the backend server 608, and the bar code 685 and the response code are presented to the merchant 601. The bar code 685 may be another representation of the response code. In another embodiment, only the bar code 685 may be presented to the merchant 601. However, it may be beneficial to provide both the bar code 685 and the response code to the merchant 601, in case the merchant does not have a bar code reader. Then, the merchant can read the bar code 685 using the barcode reader 687 and verify the read bar code by comparing with the code generated by the OTPC 683.

Further, although not shown in these figures, a combination of a simple code and a secure code such as the OTPC-generated code may be used. In this embodiment, the simple code may be used as a merchant code and the OTPC-generated code may be used as a response code, or vice versa. If the simple code is used as a merchant code, because the simple code may be constant for the lifetime of the coupon, it may be easy to maintain record of the coupon redemption using the simple code as a merchant code.

The processes described herein for validating redemption of a coupon may be advantageously implemented via software, hardware, firmware or a combination of software and/or firmware and/or hardware. For example, the processes described herein, including for providing user interface navigation information associated with the availability of services, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

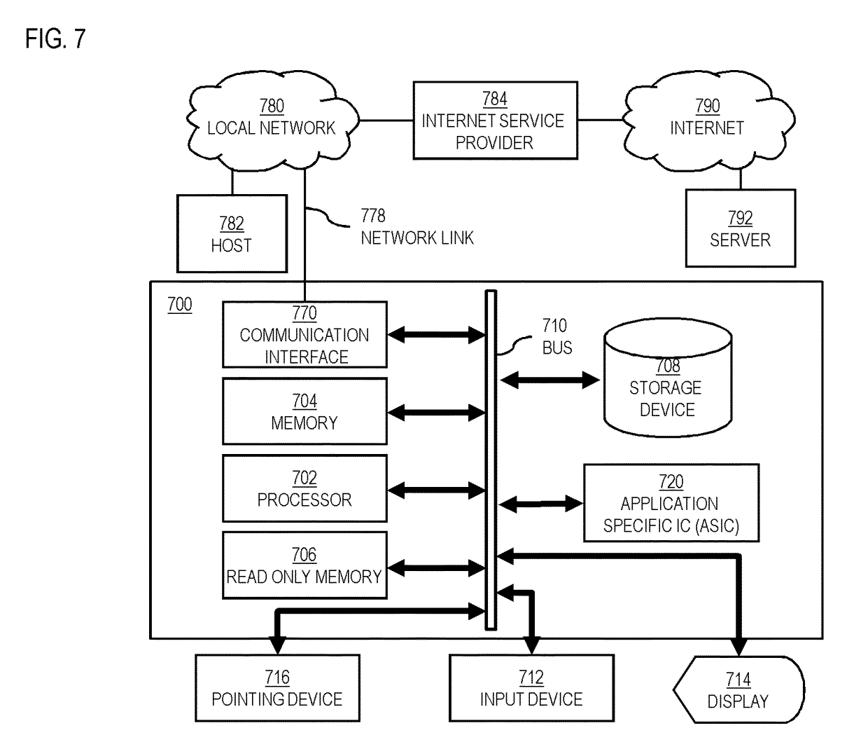

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to validate for redemption of a coupon as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of validating redemption of a coupon.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to validating redemption of a coupon. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions for validating redemption of a coupon. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for validating redemption of a coupon, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for validating redemption of a coupon.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to validate for redemption of a coupon as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of services. Chip set or chip 800, or a portion thereof, constitutes a means for performing one or more steps of validating redemption of a coupon.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to validate for redemption of a coupon. The memory 805 also stores the data associated with or generated by the execution of the inventive steps.

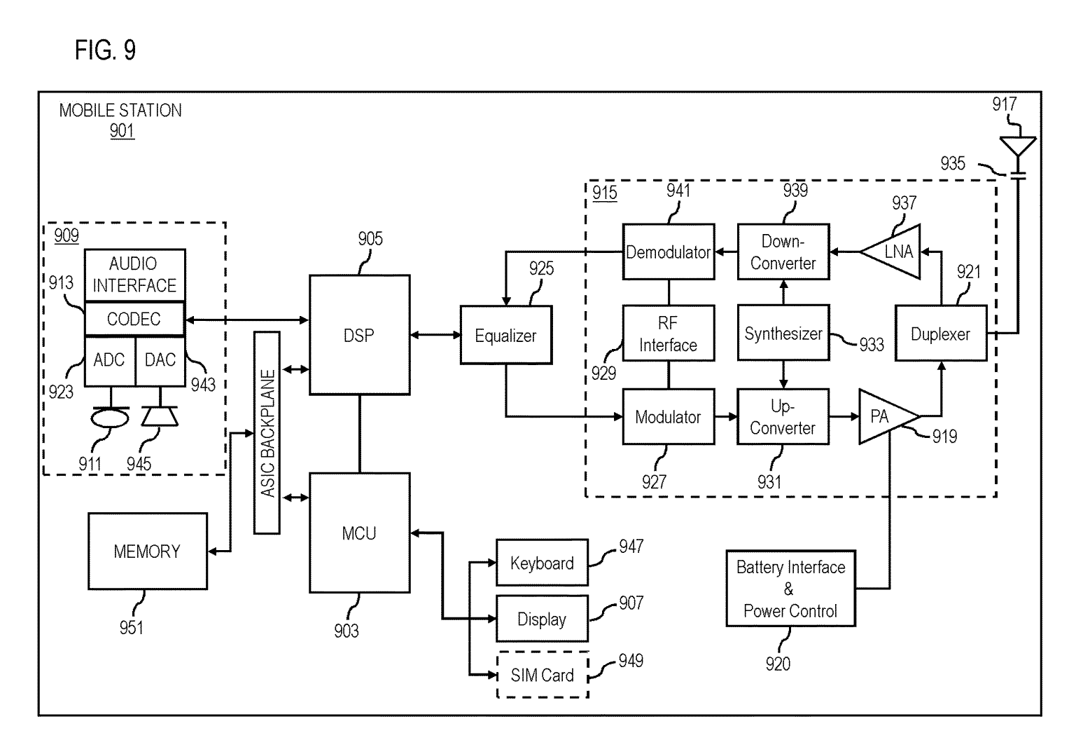

FIG. 9 is a diagram of exemplary components of a mobile terminal (e.g., handset) for communications, which is capable of operating in the system of FIG. 1, according to one embodiment. In some embodiments, mobile terminal 900, or a portion thereof, constitutes a means for performing one or more steps of validating redemption of a coupon. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of validating redemption of a coupon. The display 9 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to validate for redemption of a coupon. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
causing, at least in part, presentation of a coupon via a device;
receiving a first code in response to the presentation;
causing, at least in part, validation of a redemption of the coupon based, at least in part, on the first code, wherein the validation is performed at the device, at a server, or a combination thereof;
retrieving a second code based, at least in part, on the coupon, the first code, or a combination thereof; and
causing, at least in part, presentation of the second code for verification,
wherein the validation of the redemption of the coupon is further based, at least in part, on the verification of the second code.

2. A method of claim 1, wherein the presentation of the coupon comprises, at least in part, one or more contextual data related to the coupon, a user, the device, or a combination thereof.

3. A method of claim 1, wherein the first code is based, at least in part, on the one or more contextual data related to the coupon, the user, the device, or a combination thereof.

4. A method of claim 2, wherein the validation comprises causing, at least in part, a comparison of the one or more contextual data against other contextual data stored at the server.

5. A method of claim 1, further comprising:
generating a request to redeem the coupon, the request including, at least in part, the first code; and
causing, at least in part, transmission of the request to the server,
wherein all or a portion of the validation is performed at the server based, at least in part, on the request.

6. A method of claim 5, wherein the server maintains a log of transactions with respect to the coupon, a merchant, the device, a time of the redemption, or a combination thereof, and wherein the log is caused, at least in part, to be transmitted to the merchant for auditing.

7. A method of claim 5, wherein a connection to the server is unavailable, the method further comprising:
causing, at least in part, the validation of the redemption of the coupon at the device using validation information available within the device;
storing in the device the information about transactions with respect to the coupon, a merchant, the device, a time of the redemption, or a combination thereof; and
causing at least in part, transmission of the stored information about the transactions to the server.

8. A method of claim 1, wherein the validation of the redemption of the coupon further includes confirming distribution of coupon benefits from a sponsor of the coupon to a merchant.

9. A method of claim 1, wherein the first code is a simple code, a one-time passcode, a secure passcode, a token-based passcode, a signed passcode, an encrypted passcode, an identification code identifying a mechanism for generating the code, or a combination thereof.

10. A method of claim 1, wherein the first code is coupled with metadata, the metadata providing information about a mechanism used to generate the first code.

11. A method of claim 1, wherein the second code is a simple code, a one-time passcode, a secure passcode, a token-based passcode, a signed passcode, an encrypted passcode, or a combination thereof.

12. A method of claim 1, wherein the second code is received in response to the validation of redemption of the coupon based on the first code.

13. A method of claim 1, wherein the first code is specific to a merchant, one or more representatives of the merchant, one or more sales terminal of the merchant, the coupon, a type of the coupon, or a combination thereof.

14. A method of claim 1, wherein the presentation of the coupon includes, at least in part, a validity status, a redemption status, or a combination thereof.

15. A method of claim 1, wherein the device and the server communicate with each other via a short message service (SMS), a multimedia messaging service (MMS), a voice service, a network connection, or a combination thereof.

16. A method of claim 1, wherein the first code is received at the device via a manual input, an automatic input, an audio input, a visual input, a wireless input, or a combination thereof.

17. A method of claim 1, wherein the first code is a secure code generated by a secure code generator for a merchant.

18. An apparatus comprising:
at least one processor; and
at least one memory including computer program code for one or more programs,
the at least one memory and the computer program code configured to, with the at least one processor, cause the apparatus to perform at least the following,
cause, at least in part, presentation of a coupon via a device;
receive a first code in response to the presentation; and
cause, at least in part, validation of a redemption of the coupon based, at least in part, on the first code, wherein the validation is performed at the device, at a server, or a combination thereof;
retrieve a second code based, at least in part, on the coupon, the first code, or a combination thereof; and
cause, at least in part, presentation of the second code verification,
wherein the validation of the redemption of the coupon is further based, at least in part, on the verification of the second code.

19. An apparatus of claim 18, wherein the presentation of the coupon comprises, at least in part, one or more contextual data related to the coupon, a user, the device, or a combination thereof.

20. An apparatus of claim 18, wherein the first code is based, at least in part, on the one or more contextual data related to the coupon, the user, the device, or a combination thereof.

21. An apparatus of claim 19, wherein the validation comprises causing, at least in part, a comparison of the one or more contextual data against other contextual data stored at the server.

22. An apparatus of claim 18, wherein the apparatus is further caused to:
generate a request to redeem the coupon, the request including, at least in part, the first code; and
cause, at least in part, transmission of the request to the server,
wherein all or a portion of the validation is performed at the server based, at least in part, on the request.

23. An apparatus of claim 19, wherein the server maintains a log of transactions with respect to the coupon, a merchant, the device, a time of the redemption, or a combination thereof, and wherein the log is caused, at least in part, to be transmitted to the merchant for auditing.

24.-70. (canceled)
